(19) United States
(12) Patent Application Publication
(10) Pub. No.: US 2026/0256641 A1
(43) Pub. Date: Sep. 3, 2026

(54) MASSAGE DEVICE

(71) Applicant: SKG Health Technologies Co., Ltd., Shenzhen (CN)

(72) Inventor: Zhenxing He, Shenzhen (CN)

(21) Appl. No.: 19/427,329

(22) Filed: Dec. 19, 2025

(30) Foreign Application Priority Data
Mar. 3, 2025 (CN) 202510254455.4

(51) Int. Cl. A61H 7/00

(52) U.S. Cl. CPC A61H 7/007; A61H 2201/0207; A61H 2201/1645; A61H 2201/1652

(57) ABSTRACT

A massage device includes: a wearing housing configured to be worn on a target area; a massage mechanism arranged on the wearing housing and at least partially located on a first side of the wearing housing in a thickness direction; a binding mechanism connected to the massage mechanism and configured to bind the massage mechanism to the target area; and a cover assembly arranged on the wearing housing and at least partially located on a second side of the wearing housing opposite to the first side, the cover assembly having a protruding end protruding from the wearing housing in a direction from the first side to the second side, the protruding end being adapted to the target area.

### CROSS-REFERENCE TO RELATED APPLICATIONS

This application claims priority to Chinese Patent Application No. 202510254455.4, filed on Mar. 3, 2025, the entire contents of which are incorporated herein by reference.

### FIELD

The present disclosure relates to the technical field of massage devices, and particularly to a massage device.

### BACKGROUND

In recent years, with the improvement of people's health awareness, massage devices have increasingly entered more and more household.

After a massage device in the related art is worn on a user's target area, when the user needs to move (such as walking), the user becomes very inflexible due to interference from the massage device, and the massage device easily falls off the target area during user activity, resulting in poor massage experience.

### SUMMARY

The present disclosure provides a massage device with high fit to the target area, which allows flexible movement of the user when worn, resists detachment from the target area, and provides good massage experience.

The present disclosure provides a massage device, including a wearing housing, a massage mechanism, a binding mechanism and a cover assembly.

The wearing housing is configured to be worn on a target area.

The massage mechanism is arranged on the wearing housing and at least partially located on a first side of the wearing housing in a thickness direction.

The binding mechanism is connected to the massage mechanism and configured to bind the massage mechanism to the target area.

The cover assembly is arranged on the wearing housing and at least partially located on a second side of the wearing housing opposite to the first side. The cover assembly includes a protruding end protruding from the wearing housing in a direction from the first side to the second side, and the protruding end is adapted to the target area.

### DESCRIPTION OF DRAWINGS

FIG. 1 is a structural schematic diagram of a massage device in some embodiments.

FIG. 2 is a structural schematic diagram of the massage device in FIG. 1 when worn on a target area.

FIG. 3 is a structural schematic diagram of a massage mechanism and a binding mechanism in FIG. 1.

FIG. 4 is a structural schematic diagram of the binding mechanism detached from the massage mechanism in FIG. 3.

FIG. 5 is another perspective view of the binding mechanism and the massage mechanism in FIG. 3.

FIG. 6 is an exploded view of the massage device in FIG. 1.

FIG. 7 is another perspective view of a cover assembly in FIG. 6.

### DETAILED DESCRIPTION

The technical solutions in the embodiments of the disclosure will be clearly and completely described below with reference to the accompanying drawings. Obviously, the described embodiments are only some of the embodiments of the disclosure, and those of ordinary skill in the art can obtain other drawings based on these drawings without creative efforts.

In the disclosure, terms such as "upper", "lower", "left", "right", "front", "rear", "top", "bottom", "inner", "outer", "middle", "vertical", "horizontal", "transverse", and "longitudinal" indicate orientations or positional relationships based on the orientations or positional relationships shown in the drawings. These terms are mainly used to better describe the disclosure and its embodiments, and are not intended to limit that the indicated device, element, or component must have a specific orientation or be constructed and operated in a specific orientation.

In addition, some of the above terms may also be used to indicate other meanings, for example, the term "upper" may also be used to indicate a certain attachment relationship or connection relationship in some cases. For those of ordinary skill in the art, the specific meanings of these terms in the disclosure can be understood according to specific situations.

Furthermore, the terms "installed", "arranged", "provided with", "connected", and "connected" should be interpreted broadly. For example, it may be a fixed connection, a detachable connection, or an integral structure; it may be a mechanical connection or an electrical connection; it may be a direct connection or an indirect connection through an intermediate medium, or it may be an internal communication between two devices, elements, or components. For those of ordinary skill in the art, the specific meanings of the above terms in the disclosure can be understood according to specific situations.

Furthermore, the terms "first" and "second" are mainly used to distinguish different devices, elements, or components (the specific types and structures may be the same or different), and are not used to indicate or imply the relative importance and quantity of the indicated devices, elements, or components. Unless otherwise specified, "plurality" means two or more.

Before explaining the technical solutions of the disclosure, the related art of the disclosure will be described first.

In recent years, with the improvement of people's health awareness, massage devices have increasingly entered more and more household.

After a massage device in the related art is worn on a user's target area, when the user needs to move (such as walking), the user becomes very inflexible due to the interference of the massage device, and the massage device is also easy to fall off the target area during the user's activity, resulting in poor massage experience. Based on this, the disclosure provides a new massage device to solve the above problems.

The technical solutions of the disclosure will be further described below with reference to specific embodiments and drawings.

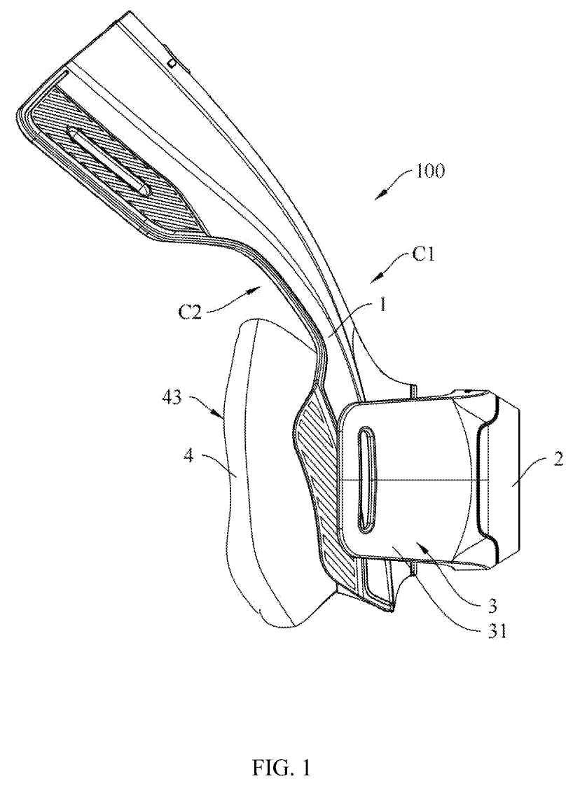

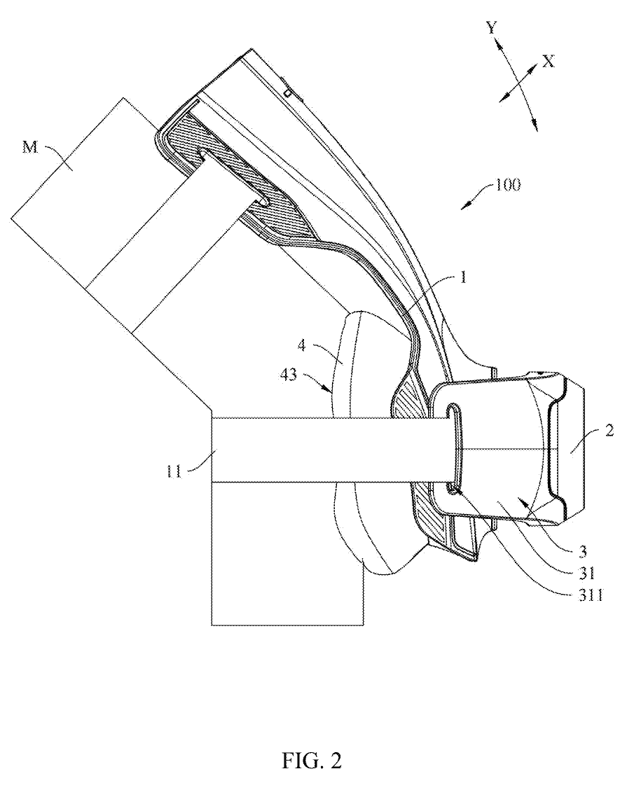

FIG. 1 is a structural schematic diagram of a massage device 100 provided by some embodiments of the disclosure, and FIG. 2 is a structural schematic diagram of the massage device 100 in FIG. 1 when worn on a target area M.

Referring to FIG. 1 and FIG. 2, the massage device 100 includes a wearing housing 1, a massage mechanism 2, a binding mechanism 3, and a cover assembly 4, wherein the wearing housing 1 is configured to be worn on the target area M, the massage mechanism 2 is arranged on the wearing housing 1 and at least partially located on a first side C1 of the wearing housing 1 in a thickness direction, the binding mechanism 3 is connected to the massage mechanism 2, the binding mechanism 3 is configured to bind the massage mechanism 2 to the target area M, the cover assembly 4 is arranged on the wearing housing 1 and at least partially located on a second side C2 of the wearing housing 1 opposite to the first side C1, the cover assembly 4 has a protruding end 43 protruding from the wearing housing 1 in a direction from the first side C1 to the second side C2, and the protruding end 43 is adapted to the target area M.

In some embodiments, when it is necessary to massage the target area M, first, the wearing housing 1 can be worn on the target area M, and the massage mechanism 2 can be bound to the target area M through the binding mechanism 3, ensuring that the protruding end 43 of the cover assembly 4 fits the target area M. Then, the massage mechanism 2 can be operated. When the massage mechanism 2 operates, it can transmit massage actions to the target area M through the cover assembly 4, so that the target area M feels pressing or kneading and shaking, thereby achieving the purpose of massaging the target area M.

Wherein, since the massage mechanism 2 is arranged on the wearing housing 1 and at least partially located on the first side C1 of the wearing housing 1 in the thickness direction, and the cover assembly 4 is arranged on the wearing housing 1 and at least partially located on the second side C2 opposite to the first side C1, that is, the massage mechanism 2 and the cover assembly 4 can be located on opposite sides of the wearing housing 1 in the thickness direction, respectively. In this way, on one hand, the massage mechanism 2 and the cover assembly 4 can make full use of the space on the opposite sides of the wearing housing 1 in the thickness direction, making the overall structure of the massage device 100 more compact and portable. On the other hand, the massage mechanism 2 can be farther from the target area M relative to the cover assembly 4, so that the cover assembly 4 can also separate the massage mechanism 2 from the target area M, thereby reducing the possibility of the massage mechanism 2 directly contacting and scratching or bruising the target area M to a certain extent, making the massage device 100 safer to use.

In addition, since the cover assembly 4 has the protruding end 43 protruding from the wearing housing 1 in the direction from the first side C1 to the second side C2, and the protruding end 43 is adapted to the target area M, when the protruding end 43 fits the target area M, the cover assembly 4 supports between the wearing housing 1 and the target area M like a support member, so that only or mostly the protruding end 43 of the cover assembly 4 fits the target area M in the entire massage device 100. In this way, on one hand, the contact area between the massage device 100 and the target area M can be reduced, thereby reducing the possibility of mutual interference between the target area M and structures of the massage device 100 other than the cover assembly 4 during movement, allowing free movement of the target area M and making the massage device 100 more user-friendly. On the other hand, it can also prevent the cover assembly 4 from partially lifting relative to the target area M when the target area M moves freely, thereby increasing the fit of the massage device 100 on the target area M and improving the massage experience.

Furthermore, since the wearing housing 1 is configured to be worn on the target area M, and the binding mechanism 3 is configured to bind the massage mechanism 2 to the target area M, the entire massage device 100 is stably fixed to the target area M under the dual fixing action of the wearing housing 1 and the binding mechanism 3 and the fitting action of the cover assembly 4 with the target area M, so that the massage device 100 will not easily fall off the target area M when the target area M moves, thus further improving the massage experience.

It should be noted that the massage device 100 may be a shoulder massager, a joint massager, a knee massager, etc., which is not limited in this embodiment.

When the massage device 100 is a knee massager, the target area M can be understood as a knee joint. Obviously, this knee massager will not make the leg stuffy, and the user can stand and walk during use without easily falling off, which is very user-friendly and has a better massage experience.

It should also be noted that the above "the massage mechanism 2 is arranged on the wearing housing 1 and at least partially located on the first side C1 of the wearing housing 1 in the thickness direction" means that the massage mechanism 2 is entirely located on the first side C1 of the wearing housing 1 in the thickness direction, or part of the massage mechanism 2 is located on the first side C1 of the wearing housing 1 in the thickness direction, and the remaining part is located on the second side C2 of the wearing housing 1 in the thickness direction. The above "at least part of the cover assembly 4 is located on the second side C2 opposite to the first side C1 of the wearing housing 1" can be understood to "at least part of the massage mechanism 2 is located on the first side C1 of the wearing housing 1 in the thickness direction", which will not be repeated in this embodiment.

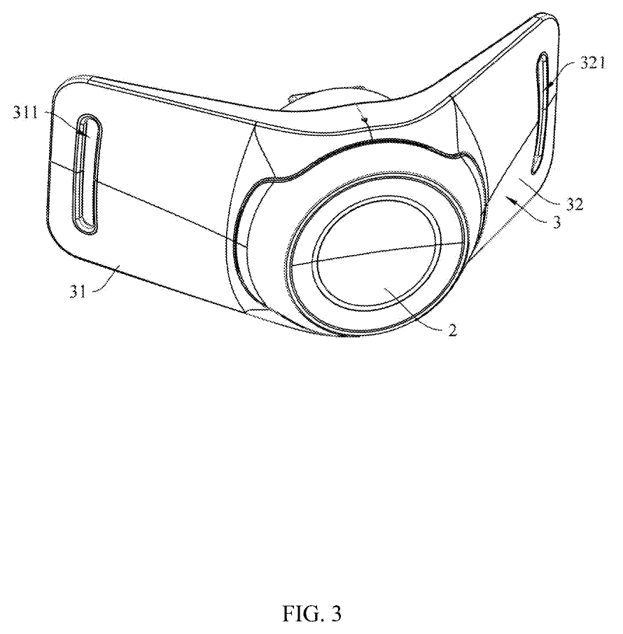

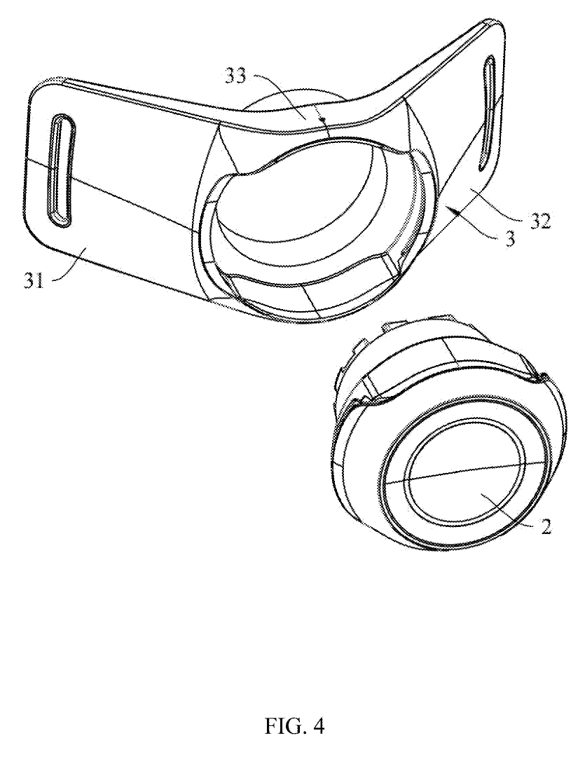

In some embodiments, referring to FIG. 2, FIG. 3, and FIG. 4, FIG. 3 is a structural schematic diagram of the massage mechanism 2 and the binding mechanism 3 in FIG. 1, and FIG. 4 is a structural schematic diagram of the binding mechanism 3 detached from the massage mechanism 2 in FIG. 3. The binding mechanism 3 includes a first binding part 31 and a second binding part 32, wherein one end of the first binding part 31 is connected to the massage mechanism 2, another end of the first binding part is detachably connected to the target area M, one end of the second binding part 32 is connected to the massage mechanism 2, and another end of the first binding part is detachably connected to the target area M.

When the binding mechanism 3 includes the first binding part 31 and the second binding part 32, the massage mechanism 2 can be bound by both the first binding part 31 and the second binding part 32, so that the massage mechanism 2 can be bound to the target area M more stably and reliably, thereby improving the fit of the massage device 100 on the target area M.

In some embodiments, referring to FIG. 1 and FIG. 2, the one end of the first binding part 31 and the one end of the second binding part 32 are both located on the first side C1.

Since the one end of the first binding part 31 and the one end of the second binding part 32 are both located on the first side C1, when the first binding part 31 and the second binding part 32 are bound to the target area M, the first binding part 31 and the second binding part 32 will be located on the side of the cover assembly 4 away from the target area M. In this way, the first binding part 31 and the second binding part 32 will surround the cover assembly 4 on the side of the cover assembly 4 away from the target area M, thereby squeezing the cover assembly 4 against the target area M and increasing the fit of the cover assembly 4 on the target area M.

In some embodiments, referring to FIG. 2 and FIG. 3, the first binding part 31 and the second binding part 32 are located on both sides of the massage mechanism 2 along a width direction (X-axis direction in FIG. 2) of the wearing housing 1.

By arranging the first binding part 31 and the second binding part 32 on both sides of the massage mechanism 2 along the width direction of the wearing housing 1, both sides of the massage mechanism 2 along the width direction of the wearing housing 1 can receive binding force from the first binding part 31 and the second binding part 32, respectively. On one hand, the massage mechanism 2 can be stably bound to the target area M, avoiding shaking of the massage mechanism 2. On the other hand, it is also convenient for the massage actions of the massage mechanism 2 to be uniformly and stably transmitted to the target area M through the first binding part 31 and the second binding part 32, making the massage effect of the massage device 100 better.

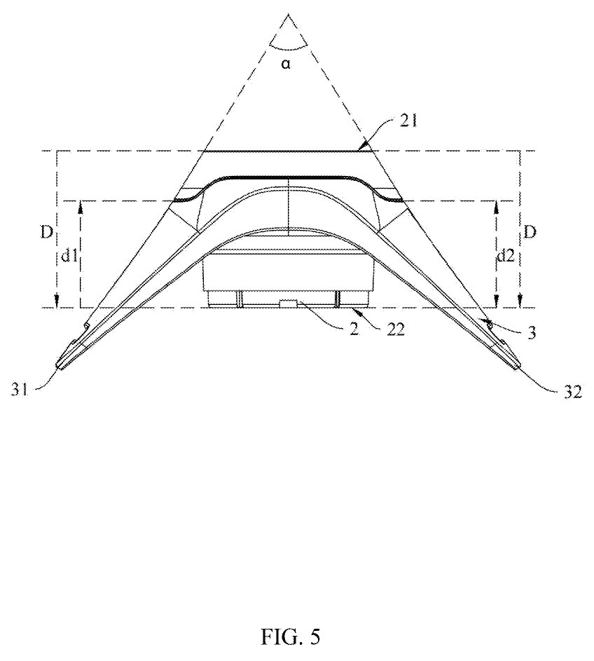

In order to enable the massage actions of the massage mechanism 2 to be transmitted to the target area M more stably, in some embodiments, referring to FIG. 5, FIG. 5 is another perspective view of the binding mechanism 3 and the massage mechanism 2 in FIG. 3. The angle between an extending direction of the first binding part 31 and an extending direction of the second binding part 32 is α, and 45° ≤ α ≤ 85°.

The inventor has found through research that when α < 45°, the first binding part 31 and the second binding part 32 are likely to interfere with the target area M, resulting in the inability to bind the massage mechanism 2 to the target area M. When α > 85°, the ability of the massage actions of the massage mechanism 2 to be transmitted to the target area M through the first binding part 31 and the second binding part 32 is weakened. Based on this, by setting 45° ≤ α ≤ 85°, on the basis of ensuring that the massage mechanism 2 can be bound to the target area M through the first binding part 31 and the second binding part 32, it can also ensure that the massage actions of the massage mechanism 2 can be well transmitted to the target area M through the first binding part 31 and the second binding part 32, thereby making the massage experience of the massage device 100 better.

In some embodiments, α can be 45°, 63°, or 85°, etc., as long as 45° ≤ α ≤ 85°, which is not limited in this embodiment.

In some embodiments, referring to FIG. 2 and FIG. 3, another end of the first binding part of the first binding part 31 is provided with a first binding hole 311, another end of the first binding part of the second binding part 32 is provided with a second binding hole 321, and a strap 11 is threaded through the first binding hole 311 and the second binding hole 321 to bind the massage mechanism 2 to the target area M.

It can be seen that by threading the strap 11 through the first binding hole 311 and the second binding hole 321, the purpose of binding the massage mechanism 2 to the target area M can be achieved, and the implementation method is very simple, which can reduce the cost of the massage device 100.

In some embodiments, referring to FIG. 4, the binding mechanism 3 further includes a binding sleeve 33, the binding sleeve 33 is sleeved on the massage mechanism 2, and the one end of the first binding part 31 and the one end of the second binding part 32 are both connected to the binding sleeve 33.

Since the binding mechanism 3 further includes the binding sleeve 33, and the one end of the first binding part 31 and the one end of the second binding part 32 are both connected to the binding sleeve 33, when it is necessary to connect the one end of the first binding part 31 and the one end of the second binding part 32 to the massage mechanism 2, the purpose can be achieved by simply sleeving the binding sleeve 33 on the massage mechanism 2, which is very convenient and quick.

Wherein, the binding sleeve 33, the first binding part 31, and the second binding part 32 may be of a split structure or an integrated structure, which is not limited in this embodiment.

In some embodiments, referring to FIG. 5, the massage mechanism 2 includes a topmost end 21 away from the target area M and a bottommost end 22 facing the target area M along the thickness direction of the wearing housing 1, and the distance between the topmost end 21 and the bottommost end 22 is D.

The maximum distance d1 between the one end of the first binding part 31 connected to the massage mechanism 2 and the bottommost end 22 satisfies (1/4)D ≤ d1 ≤ (3/4)D, and/or the maximum distance d2 between the one end of the second binding part 32 connected to the massage mechanism 2 and the bottommost end 22 satisfies (1/4)D ≤ d2 ≤ (3/4)D.

By setting (1/4)D ≤ d1 ≤ (3/4)D, the inventor has found through research that on one hand, the binding effect of the first binding part 31 on the massage mechanism 2 can be stronger, and on the other hand, the first binding part 31 can also better transmit massage actions to the target area M.

In some embodiments, d1 can be (1/4)D, (2/4)D, or (3/4)D, etc., as long as (1/4)D ≤ d1 ≤ (3/4)D, which is not limited in this embodiment.

In some embodiments, by setting (1/4)D ≤ d2 ≤ (3/4)D, the inventor has found through research that on one hand, the binding effect of the second binding part 32 on the massage mechanism 2 can be stronger, and on the other hand, the second binding part 32 can also better transmit massage actions to the target area M.

In some embodiments, d2 can be (1/4)D, (2/4)D, or (3/4)D, etc., as long as (1/4)D ≤ d2 ≤ (3/4)D, which is not limited in this embodiment.

In some embodiments, referring to FIG. 2, the massage mechanism 2 has a projection on the cover assembly 4 in a direction from the first side C1 to the second side C2; and/or the binding mechanism 3 has a projection on the cover assembly 4 in the direction from the first side C1 to the second side C2.

By making the massage mechanism 2 have a projection on the cover assembly 4, the massage mechanism 2 and the cover assembly 4 can be arranged opposite to each other, so that the massage actions of the massage mechanism 2 can be better transmitted to the cover assembly 4.

By making the binding mechanism 3 have a projection on the cover assembly 4, the binding mechanism 3 can be exactly above the cover assembly 4, so that the binding mechanism 3 can better transmit binding force to the cover assembly 4, thereby increasing the fit of the cover assembly 4 on the target area M.

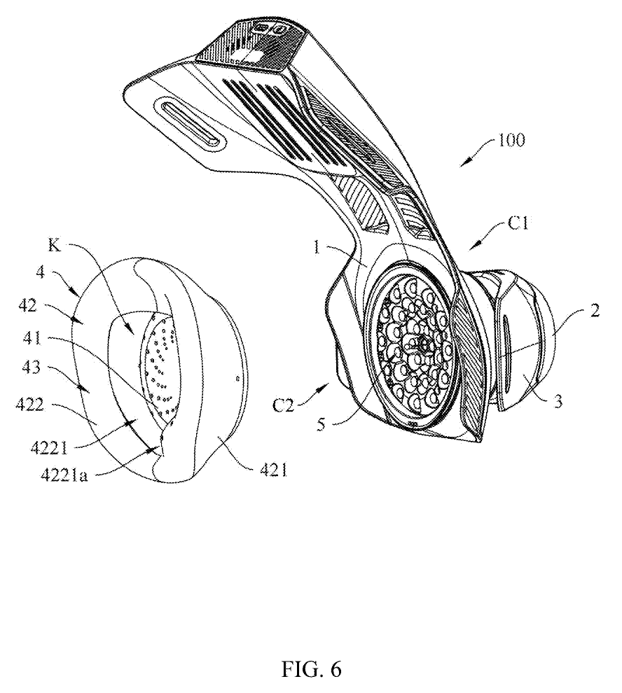

In some embodiments, referring to FIG. 6, FIG. 6 is an exploded view of the massage device 100 in FIG. 1. The massage device 100 further includes a heating assembly 5, the heating assembly 5 is arranged on the wearing housing 1 and at least partially located on the second side C2, the heating assembly 5 is configured for hot compress massage, and the protruding end 43 protrudes from the heating assembly 5 in the direction from the first side C1 to the second side C2 (the direction from right to left in FIG. 6).

When the massage device 100 further includes the heating assembly 5, the massage device 100 can also have a hot compress massage function, and the massage experience can be further improved.

By making the protruding end 43 protrude from the heating assembly 5 in the direction from the first side C1 to the second side C2, when the protruding end 43 fits the target area M, there can be a certain distance between the heating assembly 5 and the target area M, thereby preventing direct contact between the heating assembly 5 and the target area M, avoiding scalding of the target area M by the heating assembly 5, and making the massage device 100 safer to use.

The heating assembly 5 may be an infrared bulb heating assembly or a heating film heating assembly, etc., which is not limited in this embodiment.

In some embodiments, referring to FIG. 6, the heating assembly 5 is located between the wearing housing 1 and the cover assembly 4 along the thickness direction of the wearing housing 1.

By locating the heating assembly 5 between the wearing housing 1 and the cover assembly 4, on one hand, the wearing housing a and the cover assembly 4 can wrap the heating assembly 5, making the environment where the heating assembly 5 is located safer, thereby reducing the impact of the external environment on the heating assembly 5 and increasing the durability of the heating assembly 5. On the other hand, it can also reduce the occurrence of scalding the user due to the heating assembly 5 being directly exposed, making the massage device 100 safer to use.

In some embodiments, the cover assembly 4 may be a silica gel cover assembly 4. When the cover assembly 4 is a silica gel cover assembly 4, the cover assembly 4 can transmit light, so that the heating assembly 5 can be seen through the cover assembly 4, achieving a visible hot compress effect.

In some embodiments, referring to FIG. 6, the cover assembly 4 includes a heat insulation portion 41 and a fitting portion 42, wherein the heat insulation portion 41 covers the heating assembly 5 and is located on the side of the heating assembly 5 facing the second side C2, the fitting portion 42 covers the heat insulation portion 41 and is located on the side of the heat insulation portion 41 facing the second side C2, and the fitting portion 42 has the protruding end 43.

Since the heat insulation portion 41 covers the heating assembly 5 and is located on the side of the heating assembly 5 facing the second side C2, and the fitting portion 42 covers the heat insulation portion 41 and is located on the side of the heat insulation portion 41 facing the second side C2, and the fitting portion 42 has the protruding end 43, the heat insulation portion 41 can block the protruding end 43 from the heating assembly 5, so that the protruding end 43 does not directly contact the heating assembly 5, thereby preventing the protruding end 43 from scalding the target area M.

In some embodiments, referring to FIG. 6, the heat insulation portion 41 and the fitting portion 42 are integrally formed.

By integrally forming the fitting portion 42 and the heat insulation portion 41, the integrity of the cover assembly 4 can be improved, thereby reducing the number of parts of the massage device 100 and simplifying the structure of the massage device 100.

In some embodiments, the fitting portion 42 and the heat insulation portion 41 can be integrally formed in various ways. In one possible implementation, the fitting portion 42 and the heat insulation portion 41 can be integrally formed by injection molding. Of course, the fitting portion 42 and the heat insulation portion 41 can also be integrally formed by other methods, which is not limited in this embodiment.

In addition, the material of the fitting portion 42 and the heat insulation portion 41 may be silica gel or rubber, etc., which is not limited in this embodiment.

In some embodiments, referring to FIG. 6, the fitting portion 42 includes an enclosing wall 421 and a fitting wall 422, wherein one end of the enclosing wall 421 is arranged on the heat insulation portion 41, another end of the first binding part is located on the side of the heat insulation portion 41 facing the second side C2, the fitting wall 422 is arranged on another end of the first binding part of the enclosing wall 421, the fitting wall 422 and the enclosing wall 421 enclose to form a cavity K, at least part of the heat insulation portion 41 is located in the cavity K, and the fitting wall 422 forms the protruding end 43.

Since the fitting wall 422 is arranged on another end of the first binding part of the enclosing wall 421, and the fitting wall 422 and the enclosing wall 421 enclose to form the cavity K, and at least part of the heat insulation portion 41 is located in the cavity K, when the heat of the heating assembly 5 is transmitted to the cavity K through the heat insulation portion 41, the heat can be retained in the cavity K for hot compress under the action of the enclosing wall 421, avoiding a large amount of heat from flowing out to the external environment and causing heat loss, thereby making the hot compress effect of the massage device 100 better.

In some embodiments, referring to FIG. 6, the cross-sectional dimension of the enclosing wall 421 gradually increases in the direction from the first side C1 to the second side C2 (the direction from right to left in FIG. 6).

This arrangement can make the size of the fitting wall 422 larger, thereby making the size of the protruding end 43 larger. When the size of the protruding end 43 is larger, the contact area between the protruding end 43 and the target area M can be larger, thereby enabling the cover assembly 4 to fit the target area M more stably.

It should be noted that the above "the cross-sectional dimension of the enclosing wall 421 gradually increases in the direction from the first side C1 to the second side C2 (the direction from right to left in FIG. 6)" is only one possible implementation of the enclosing wall 421 provided in this embodiment. In another possible implementation, the cross-sectional dimension of the enclosing wall 421 may also gradually decrease or remain unchanged in the direction from the first side C1 to the second side C2 (the direction from right to left in FIG. 6), which is not limited in this embodiment.

In some embodiments, referring to FIG. 6, the thickness of the enclosing wall 421 is greater than the thickness of the fitting wall 422.

Since the enclosing wall 421 can support the fitting wall 422, and the fitting wall 422 mainly contacts the target area M, by making the thickness of the enclosing wall 421 greater than the thickness of the fitting wall 422, the enclosing wall 421 can well support the fitting wall 422, thereby reducing the occurrence of scalding the target area M due to direct contact between the fitting wall 422 and the heat insulation portion 41 when the fitting wall 422 is subjected to external force toward the heat insulation portion 41. At the same time, the fitting wall 422 has a soft touch, making the massage experience of the massage device 100 better and more comfortable.

In some embodiments, referring to FIG. 6, a deformation window 4221 is opened on the fitting wall 422, the deformation window 4221 is in communication with the cavity K, and the deformation window 4221 is adapted to the target area M.

By providing the deformation window 4221, on one hand, the fitting wall 422 can fit the target area M more stably. On the other hand, the deformation window 4221 can also play a role in ventilation, thereby avoiding the situation where the target area M is too stuffy and affects the massage experience.

In some embodiments, referring to FIG. 6, the deformation window 4221 has a tapered end 4221a along a length direction of the wearing housing 1.

By making the deformation window 4221 have the tapered end 4221a, the tapered end 4221a can play a role similar to a limiting hole, so that the target area M can be more stably fixed in the deformation window 4221, thereby improving the fit between the fitting wall 422 and the target area M.

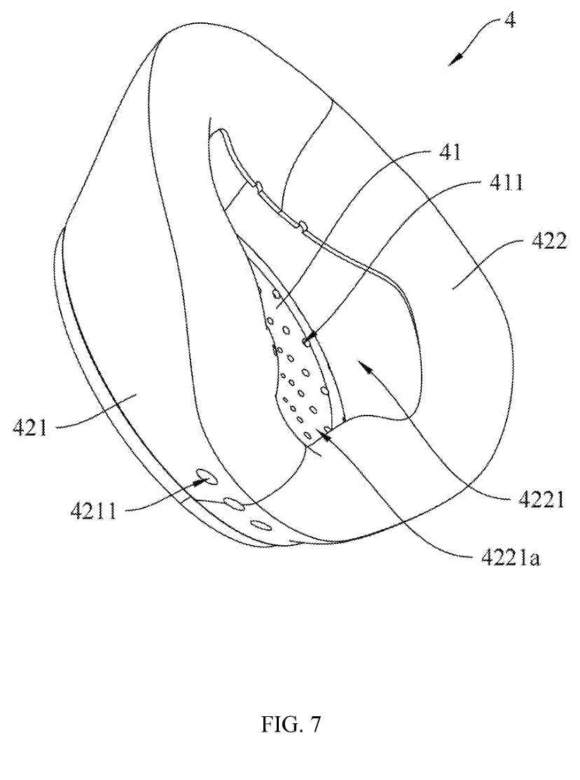

In some embodiments, referring to FIG. 7, FIG. 7 is another perspective view of the cover assembly 4 in FIG. 6. A plurality of deformation holes 4211 are arranged on the enclosing wall 421 at a position close to the tapered end 4221a.

By disposing a plurality of deformation holes 4211 on the enclosing wall 421 at a position close to the tapered end 4221a, this part of the enclosing wall 421 can have strong deformation ability, thereby enabling the deformation window 4221 to better adapt to the target area M, and further improving the fit between the fitting wall 422 and the target area M.

Wherein, the shape of the deformation holes 4211 may be circular or strip-shaped, etc., which is not limited in this embodiment. The number of the deformation holes 4211 may be three, four, or five, etc., and the number of the deformation holes 4211 is not limited in this embodiment.

In some embodiments, referring to FIG. 6 and FIG. 7, a through hole 411 is arranged on the heat insulation portion 41, and the through hole 411 penetrates through the heat insulation portion 41 in the direction from the first side C1 to the second side C2.

By disposing the through hole 411 on the heat insulation portion 41, on one hand, it is convenient for the heat of the heating assembly 5 to be transmitted to the cavity K through the through hole 411 and then to the fitting wall 422, making the hot compress massage effect of the massage device 100 better. On the other hand, the through hole 411 can also play a role in exhausting air, thereby avoiding the situation where the cavity K forms a closed space when the fitting wall fits the target area M, resulting in excessive air pressure in the cavity K and preventing the target area M from fitting the fitting wall 422 well.

Wherein, the number of the through holes 411 may be multiple, and the multiple through holes 411 are arranged in an array on the heat insulation portion 41. The shape of the through holes 411 may be circular, square, or other possible shapes, which is not limited in this embodiment.

Finally, it should be noted that the above embodiments are only used to illustrate the technical solutions of the disclosure, but not to limit them; although the disclosure has been described in detail with reference to the foregoing embodiments, those of ordinary skill in the art should understand that they can still modify the technical solutions described in the foregoing embodiments, or replace some or all of the technical features thereof; and these modifications or replacements do not make the essence of the corresponding technical solutions depart from the scope of the technical solutions of the embodiments of the disclosure.

What is claimed is:

1. A massage device, comprising:
a wearing housing, the wearing housing being configured to be worn on a target area;
a massage mechanism, the massage mechanism being arranged on the wearing housing and at least partially located on a first side of the wearing housing in a thickness direction;
a binding mechanism, the binding mechanism being connected to the massage mechanism and configured to bind the massage mechanism to the target area; and
a cover assembly, the cover assembly being arranged on the wearing housing and at least partially located on a second side of the wearing housing opposite to the first side, the cover assembly having a protruding end protruding from the wearing housing in a direction from the first side to the second side, the protruding end being adapted to the target area.

2. The massage device according to claim 1, wherein the binding mechanism comprises:
a first binding part, one end of the first binding part being connected to the massage mechanism, and another end of the first binding part being detachably connected to the target area; and
a second binding part, one end of the second binding part being connected to the massage mechanism, and another end of the first binding part being detachably connected to the target area.

3. The massage device according to claim 2, wherein the one end of the first binding part and the one end of the second binding part are both located on the first side.

4. The massage device according to claim 3, wherein the first binding part and the second binding part are located on both sides of the massage mechanism along a width direction of the wearing housing.

5. The massage device according to claim 4, wherein an angle between an extending direction of the first binding part and an extending direction of the second binding part is defines as α, the massage device satisfies 45° ≤ α ≤ 85°.

6. The massage device according to claim 2, wherein another end of the first binding part of the first binding part is provided with a first binding hole, another end of the first binding part of the second binding part is provided with a second binding hole, and a strap is threaded through the first binding hole and the second binding hole to bind the massage mechanism to the target area.

7. The massage device according to claim 2, wherein the binding mechanism further comprises a binding sleeve, the binding sleeve is sleeved on the massage mechanism, and the one end of the first binding part and the one end of the second binding part are both connected to the binding sleeve.

8. The massage device according to claim 2, wherein
the massage mechanism comprises a topmost end away from the target area and a bottommost end facing the target area along the thickness direction of the wearing housing, and a distance between the topmost end and the bottommost end is defined as D;
a maximum distance between the one end of the first binding part connected to the massage mechanism and the bottommost end is defined as d1 and (1/4)D ≤ d1 ≤ (3/4)D, and/or a maximum distance between the one end of the second binding part connected to the massage mechanism and the bottommost end is defined as d2 and (1/4)D ≤ d2 ≤ (3/4)D.

9. The massage device according to claim 1, wherein
the massage mechanism has a projection on the cover assembly in the direction from the first side to the second side; and/or the binding mechanism has a projection on the cover assembly in the direction from the first side to the second side.

10. The massage device according to claim 1, further comprising
a heating assembly, the heating assembly being arranged on the wearing housing and at least partially located on the second side, the heating assembly being configured for hoting compress massage, and the protruding end protruding from the heating assembly in the direction from the first side to the second side.

11. The massage device according to claim 10, wherein
the heating assembly is located between the wearing housing and the cover assembly along the thickness direction of the wearing housing.

12. The massage device according to claim 11, wherein the cover assembly comprises:
a heat insulation portion, the heat insulation portion covering the heating assembly and located on a side of the heating assembly facing the second side; and
a fitting portion, the fitting portion covering the heat insulation portion and located on a side of the heat insulation portion facing the second side, the fitting portion having the protruding end.

13. The massage device according to claim 12, wherein the heat insulation portion and the fitting portion are integrally formed.

14. The massage device according to claim 12, wherein the fitting portion comprises:
an enclosing wall, one end of the enclosing wall being arranged on the heat insulation portion, and another end of the first binding part being located on a side of the heat insulation portion facing the second side; and
a fitting wall, the fitting wall being arranged on another end of the first binding part of the enclosing wall, the fitting wall and the enclosing wall enclosing to form a cavity, at least part of the heat insulation portion being located in the cavity, and the fitting wall forming the protruding end.

15. The massage device according to claim 14, wherein a cross-sectional dimension of the enclosing wall gradually increases in the direction from the first side to the second side.

16. The massage device according to claim 15, wherein a thickness of the enclosing wall is greater than a thickness of the fitting wall.

17. The massage device according to claim 14, wherein a deformation window is opened on the fitting wall, the deformation window is in communication with the cavity, and the deformation window is adapted to the target area.

18. The massage device according to claim 17, wherein the deformation window has a tapered end along a length direction of the wearing housing.

19. The massage device according to claim 18, wherein a plurality of deformation holes are arranged on the enclosing wall at a position close to the tapered end.

20. The massage device according to claim 12, wherein a through hole is arranged on the heat insulation portion, and the through hole penetrates through the heat insulation portion in the direction from the first side to the second side.
